(19) United States
(12) Patent Application Publication
(10) Pub. No.: US 2013/0268826 A1
(43) Pub. Date: Oct. 10, 2013

(54) SYNCHRONIZING PROGRESS IN AUDIO AND TEXT VERSIONS OF ELECTRONIC BOOKS

(71) Applicants: MACIEJ SZYMON NOWAKOWSKI, Zurich (CH); BALAZS SZABO, Oberrieden (CH)

(72) Inventors: MACIEJ SZYMON NOWAKOWSKI, Zurich (CH); BALAZS SZABO, Oberrieden (CH)

(73) Assignee: GOOGLE INC., Mountain View, CA (US)

(21) Appl. No.: 13/441,635

(22) Filed: Apr. 6, 2012

(51) Int. Cl. G06F 17/00; G06F 17/30

(52) U.S. Cl. 715/203

(57) ABSTRACT

An electronic book system is configured to allow a user to listen to an audio version of an electronic book, then switch to reading a text version of the book on a different device, the text version being presented from the point where the audio version left off. One or more users can repeatedly switch from audio to text versions without losing track of their progress through the book. Correlation between audio and text versions is established by generating a correlation table or inserting position-related metadata in the audio or text data files.

### BACKGROUND

1. Technical Field

The subject matter described herein generally relates to the field of electronic media and, more particularly, to systems and methods for tracking a reader's progress through audio and text versions of electronic books.

2. Background Information

Electronic book readers, implemented on special-purpose devices as well as on conventional desktop, laptop and hand-held computers, have become commonplace. Usage of such readers has accelerated dramatically in recent years. Electronic book readers provide the convenience of having numerous books available on a single device, and also allow different devices to be used for reading in different situations. Systems and methods are known to allow a user's progress through such an electronic book to be tracked on any device the user may have, so that someone reading a book on a smart phone while commuting home on a bus can seamlessly pick up at the correct page when later accessing the electronic book from a desktop computer at home.

Electronic books are available not only in conventional text form for visual reading, but also in audio form. Many readers prefer reading a book in a traditional manner (i.e., viewing it in text form) but would also like to progress through the book at times when traditional reading may not be feasible, such as when commuting to work while driving an automobile. Other readers may find it advantageous to listen to a book (or audio from a lecture) and follow along as needed in the text version of the book (or, correspondingly, a text transcript of the lecture). It would be advantageous to extend the benefits of electronic books yet further, for instance to allow synchronization of reading between audio and textual versions of an electronic book.

A related consideration is creation of electronic books in a manner that permits simple synchronization between audio and textual versions of a book. It would be advantageous to provide a system and method for simple correlation of portions of the audio and textual version to facilitate synchronization.

### SUMMARY

An electronic book system synchronizes progress in audio and text versions of an electronic book. The system includes a system database storing user progress data, audio book data corresponding to the audio version and textual book data corresponding to the text version; the audio book data includes audio position information and the textual book data includes text position information. A correlation data store maintains correlation data indicating correspondence between the audio position information and the text position information. An audio playback system presents the audio version of the electronic book to a user responsive to the user progress data and the correlation data; a display subsystem presents the text version of the electronic book to the user responsive to the user progress data and the correlation data.

In one aspect, the audio position data is a time code or a percentage of completion and the text position information is a page number, a paragraph number, a line number, a word number or a character number. In another aspect, the correlation data is stored as metadata for at least one of the audio book data and the textual book data.

To obtain the data to allow synchronization between audio and text versions of an electronic book, a system correlates audio position information for the audio version with text position information data for the text version. The system includes a system database configured to maintain audio book data corresponding to the audio version and textual book data corresponding to the text version; an audio processing subsystem configured to process the audio version so as to allow comparison of the audio version with the text version; and a correlation subsystem configured to generate correlation information establishing a correspondence between the audio position information and the text position information responsive to the comparison, and to store the correlation information in the system database.

In a related aspect, the system includes a display subsystem configured to display the text version to a content provider, and the correlation subsystem further includes a user interface control configured to allow the content provider to establish the correspondence. In another related aspect, the user interface is configured so that a content provider's finger press on a portion of the text version establishes a correspondence with a portion of the audio version being played at the time of the finger press; in yet another aspect the user interface establishes the finger press from a finger trace formed by the content provider following the text version as the audio version plays. In a different aspect, the audio processing subsystem comprises a voice recognition subsystem configured to accept the audio version as input and produce as output a text rendition of the audio version, and the comparison is of the text rendition of the audio version with the text version.

Related methods are also disclosed herein.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF THE DRAWINGS

FIG. 1 is a high-level diagram illustrating a networked environment that includes an electronic book reader.

FIG. 2 illustrates a logical view of a reader module used as part of an electronic book reader.

FIG. 3 illustrates a logical view of a system database that stores data and performs processing related to the content hosting system.

FIG. 4 illustrates one embodiment of components of an example machine able to read instructions from a machine-readable medium and execute them in a processor.

FIG. 5 illustrates one exemplary method of synchronizing audio and text versions of an electronic book.

FIG. 6 illustrates a computer configured to enable establishment of correlation data between audio and text versions of an electronic book.

The figures depict various embodiments for purposes of illustration only. One skilled in the art will readily recognize from the following discussion that alternative embodiments of the structures and methods illustrated herein may be employed without departing from the principles of the invention described herein.

### DETAILED DESCRIPTION

### Electronic Book System Overview

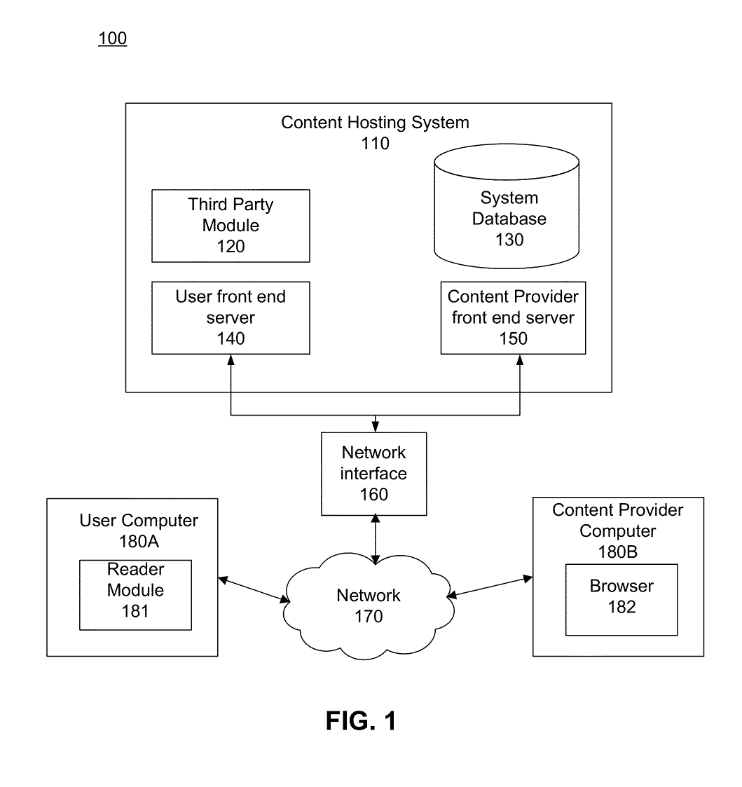

FIG. 1 is a high-level diagram illustrating a networked environment 100 that includes a content hosting system 110. The content hosting system 110 makes available for purchase, licensing, rental or subscription books that can be viewed on user and content provider computers 180 (depicted in FIG. 1, for exemplary purposes only, as individual computers 180A and 180B) using a reader module 181 or browser 182. The content hosting system 110 and computers 180 are connected by a network 170 such as a local area network or the Internet. As further detailed herein, the content hosting system 110 includes audio and text-based versions of an electronic book for the user to access via user computer 180A, as well as subsystems to provide synchronization information for each such version.

The network 170 is typically the Internet, but can be any network, including but not limited to any combination of a LAN, a MAN, a WAN, a mobile, a wired or wireless network, a private network, or a virtual private network. The content hosting system 110 is connected to the network 170 through a network interface 160.

Only a single user computer 180A is shown in FIG. 1, but in practice there are many (e.g., millions of) user computers 180A that can communicate with and use the content hosting system 110. Similarly, only a single content provider computer 180B is shown, but in practice there are many (e.g., thousands or even millions of) content provider computers 180B that can provide books and related materials for content hosting system 110. In some embodiments, reader module 181 and browser 182 include a content player (e.g., FLASH™ from Adobe Systems, Inc.), or any other player adapted for the content file formats used by the content hosting system 110. In a typical embodiment, user computers 180A and content provider computers 180B are implemented with various computing devices, ranging from desktop personal computers to tablet computers, dedicated book reader devices, and smartphones.

User computer 180A with reader module 181 is used by end users to purchase or otherwise obtain, and access, materials provided by the content hosting system 110. Content provider computer 180B is used by content providers (e.g., individual authors, publishing houses) to create and provide material for the content hosting system 110. A given computer can be both a client computer 180A and content provider computer 180B, depending on its usage. The hosting service 110 may differentiate between content providers and users in this instance based on which front end server is used to connect to the content hosting system 110, user logon information, or other factors.

The content hosting system 110 comprises a user front end server 140 and a content provider front end server 150, each of which can be implemented as one or more server class computers. The content provider front end server 150 is connected through the network 170 to content provider computer 180B. The content provider front end server 150 provides an interface for content providers—whether traditional book publishers or individual self-publishing authors—to create and manage materials they would like to make available to users. The user front end server 140 is connected through the network 170 to client computer 180A. The user front end server 140 provides an interface for users to access material created by content providers. In some embodiments, connections from network 170 to other devices (e.g., client computer 180A) are persistent, while in other cases they are not, and information such as reading progress data is transmitted to other components of system 110 only episodically (i.e., when connections are active).

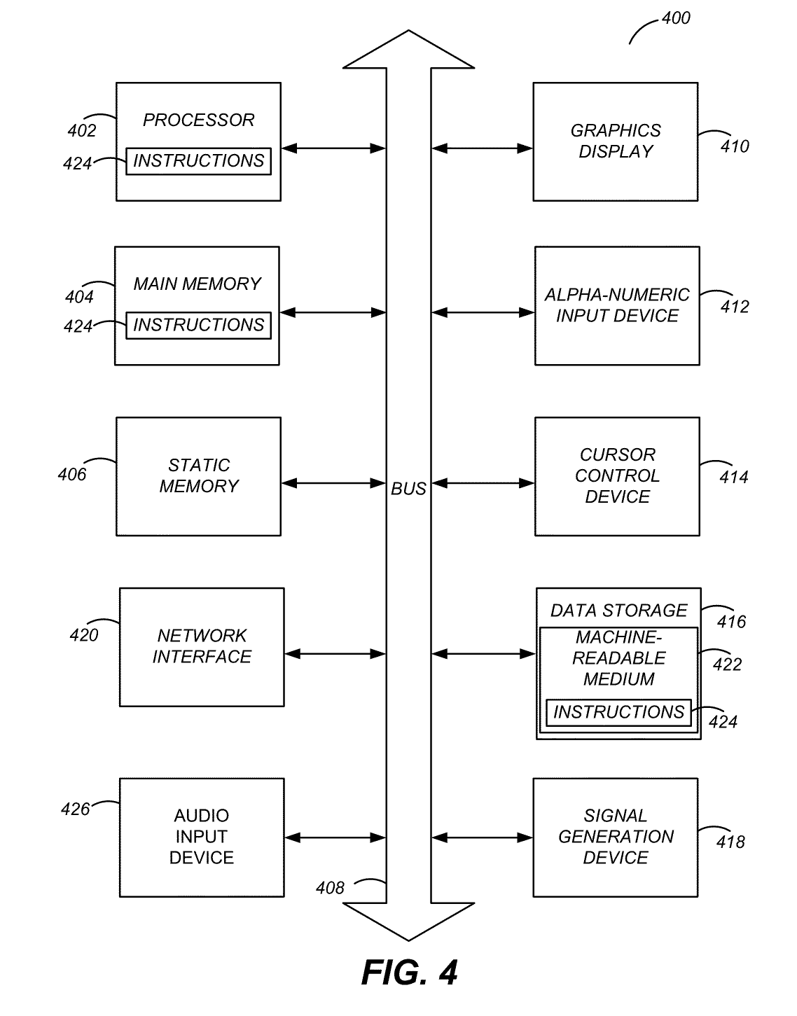

The content hosting system 110 is implemented by a network of server class computers that can in some embodiments include one or more high-performance CPUs and 1 G or more of main memory, as well as storage ranging from hundreds of gigabytes to petabytes. An operating system such as LINUX is typically used. The operations of the content hosting system 110, user front end server 140 and content provider front end server 150 as described herein can be controlled through either hardware (e.g., dedicated computing devices or daughter-boards in general purpose computers), or through computer programs installed in computer storage on the servers of the system 110 and executed by the processors of such servers to perform the functions described herein. More detail regarding implementation of such machines is provided in connection with FIG. 4. One of skill in the art of system engineering and, for example, media content hosting will readily determine from the functional and algorithmic descriptions herein the construction and operation of such computer programs and hardware systems.

The content hosting system 110 further comprises a system database 130 that is communicatively coupled to the network 170. The system database 130 stores data related to the content hosting system 110 along with user and system usage information and, in some embodiments, provides related processing (e.g., the correlation functions described herein).

The system database 130 can be implemented as any device or combination of devices capable of storing data in computer readable storage media, such as a hard disk drive, RAM, a writable compact disk (CD) or DVD, a solid-state memory device, or other optical/magnetic storage mediums. Other types of computer-readable storage mediums can be used, and it is expected that as new storage mediums are developed in the future, they can be configured in accordance with the descriptions set forth above.

The content hosting system 110 is further comprised of a third party module 120. The third party module 120 is implemented as part of the content hosting system 110 in conjunction with the components listed above. The third party module 120 provides a mechanism by which the system provides an open platform for additional uses relating to electronic books, analogous to how an application programming interface allows third parties access to certain features of a software program. In some embodiments, third party input may be limited to provision of content via content provider computers 180B and content provider front end server 150. Given the wide range of possible operation of system 100, however, in some embodiments it may be desirable to open additional capabilities for third parties who are not providing content to access the system. For example, anonymous use data from groups of readers may be made available via third party module 120 to allow development of reading statistics for particular books. As a specific example, aggregated data regarding user preference for audio or text-based versions of a particular book may be used to determine rankings for voice actors narrating books, incentives for use of various types of reading devices that favor text-based or audio versions, etc. In a typical embodiment, the user is provided with various options regarding the information collected and processed as described herein, and the user (or parents, teachers, etc. for younger users) can opt not to have certain information about the user collected or used, if the user would rather not provide such information. The text and audio synchronization functions described herein are in some embodiments implemented directly via content hosting system 110 and in other embodiments implemented via third party module 120.

In this description, the term “module” refers to computational logic for providing the specified functionality. A module can be implemented in hardware, firmware, and/or software. Where the modules described herein are implemented as software, the module can be implemented as a standalone program, but can also be implemented through other means, for example as part of a larger program, as a plurality of separate programs, or as one or more statically or dynamically linked libraries. It will be understood that the named modules described herein represent one embodiment of the present invention, and other embodiments may include other modules. In addition, other embodiments may lack modules described herein and/or distribute the described functionality among the modules in a different manner. Additionally, the functionalities attributed to more than one module can be incorporated into a single module. In an embodiment where the modules as implemented by software, they are stored on a computer readable persistent storage device (e.g., hard disk), loaded into the memory, and executed by one or more processors included as part of the content hosting system 110. Alternatively, hardware or software modules may be stored elsewhere within the content hosting system 110. The content hosting system 110 includes hardware elements necessary for the operations described here, including one or more processors, high speed memory, hard disk storage and backup, network interfaces and protocols, input devices for data entry, and output devices for display, printing, or other presentations of data. FIG. 4 provides further details regarding such components.

Numerous variations from the system architecture of the illustrated content hosting system 110 are possible. The components of the system 110 and their respective functionalities can be combined or redistributed. For example, the system database 130, third party module 120, user front end server 140, and content provider front end server 150 can be distributed among any number of storage devices. The following sections describe in greater detail the reader module 181, system database 130, and the other components illustrated in FIG. 1 in greater detail, and explain their operation in the context of the content hosting system 110.

### Reader Module

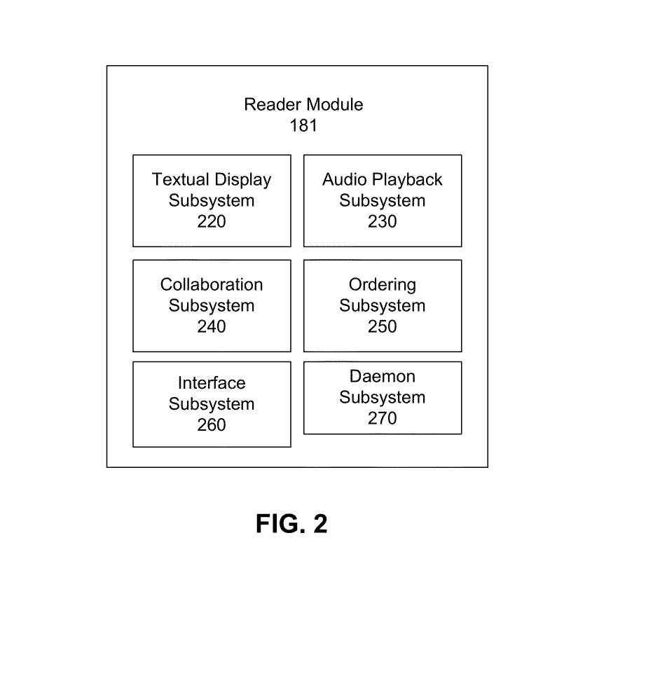

FIG. 2 illustrates a functional view of a reader module 181 used as part of a electronic book system. In the embodiment described above in connection with FIG. 1, the reader module is implemented on user computer 180A, but it should be recognized that in other embodiments, portions discussed herein could also be implemented on other computers (e.g., those in content hosting system 110) that are in communication with reader module 181.

Reader module 181 is configured, in the aspects discussed herein, to address the text and audio synchronization features detailed below. As described below, some of these features are interactive and may involve connections to map applications, provision of different types of advertisements, and the like. The features discussed below are social and collaborative as well. For example, while it is typical for only one person to read a text-based version of a book, multiple people (e.g., those in a carpool) might listen to a single audio version of the same book simultaneously.

Reader module 181 includes various subsystems to facilitate these specialized uses. In the embodiment illustrated in FIG. 2, reader module 181 includes a textual display subsystem 220, an audio playback subsystem 230, a collaboration subsystem 240, an ordering subsystem 250, an interface subsystem 260, and a daemon subsystem 270. Many of these subsystems interact with one another, as described below.

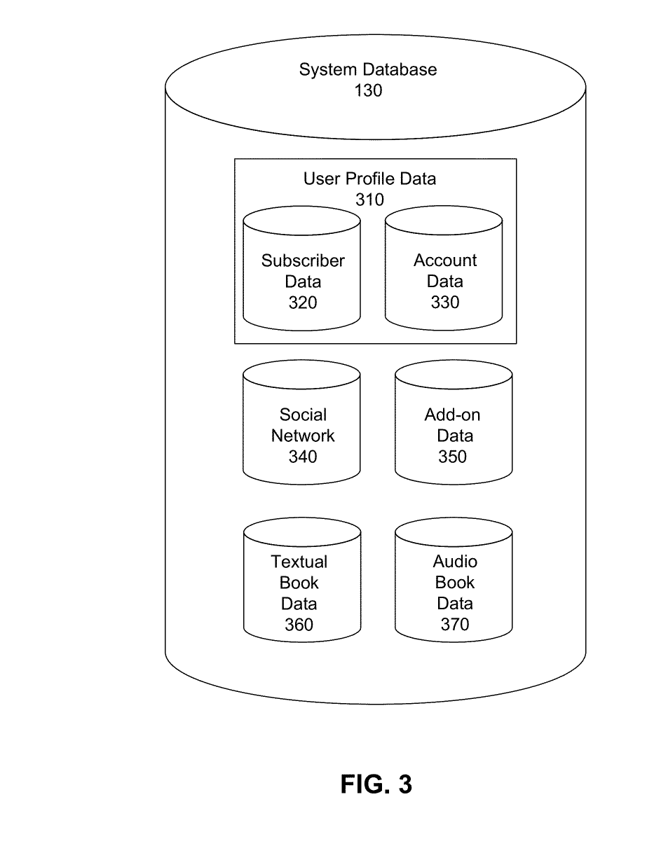

Textual display subsystem 220 provides an interface for conventional text-based reading of an electronic book. In some embodiments, this subsystem also includes facilities for keeping track of a reader's progress, for instance by reporting, through interface subsystem 260, the current page being viewed to a centralized database (e.g., user profile data section 310 of system database 130 as illustrated in FIG. 3). Typically, such facilities can only keep track of reading on a screen-by-screen basis, as the reader pages through the text. In some embodiments, however, biometric approaches known to those skilled in the art are employed to track a reader's progress with finer granularity, such as by use of gaze analysis from data gathered by a camera integrated in client computer 180A.

Audio playback subsystem 230 provides audio book features that permit the user to read a book by listening to its contents. Various features facilitate such use, including live streaming of an audio files (for instance with a famous actor reading the book), real-time speech synthesis from the text version of the book, downloading of an audio file (e.g., one or more .mp3 files) corresponding to audio for the book to allow audio reading when online access is not available, and the like. In some embodiments, this subsystem also includes facilities for keeping track of a reader's progress, for instance by reporting, through interface subsystem 260, the time code or percentage of completion when the audio playback ceases (again, for instance, via user profile data section 310 of system database 130 as illustrated in FIG. 3).

While the discussion here has focused on audio alone, other types of media are also supported in various embodiments. For example, a biography or a historical novel may, in original paper form, have a section including various pictures, maps or other graphics. In one embodiment, audio playback subsystem 230 also provides still images (or video, if available) corresponding to the portion of the book being presented in audio format. In yet another embodiment, audio playback via audio playback subsystem 230 occurs simultaneously with text-based display of the book (via textual display subsystem 220), for instance in environments in which audio playback is used in a manner to assist the user with learning how to read. In such an environment, the synchronization between audio and text-based versions is also used to highlight text (e.g., by underlining text or coloring a background area) that corresponds with the currently playing audio content.

Further, the term “electronic book” as used herein can apply not only to traditional books, but to other types of content as well, for instance a professor's lecture that may be reviewed in text transcript form on an electronic book reader or in audio form from a recording of the original live lecture.

Collaboration subsystem 240 provides various user functions that allow readers to work with others. For example, if several people are in a carpool together, they may decide to read the same book by combining audio playback of the book while commuting with text-based reading at other times. Collaboration subsystem 240 permits such users to indicate their common activity, via a social network (e.g., social network 340 as maintained in system database 130 of FIG. 3) so that each can keep track of progress through a book. Collaboration subsystem 240 in one embodiment permits a person who is playing back an audio version of a book to link other users to that audio version so that synchronization information extends not only to the primary user, but to others as well. In one embodiment, system 110 prompts each such user to “catch up” by reading portions preceding those that were presented to the group via audio. In another embodiment, a “slowest reader” option starts audio playback at the earliest unread portion for members of the group, so that no one misses any portion of the book. In still another embodiment, options allow audio to begin at the “fastest reader” position (i.e., the position of the reader who is furthest along in the book) or at some intermediate point (e.g., a weighted average of where the group of readers are, in one specific embodiment giving different weights to each reader for instance to favor faster readers and thereby promote additional reading).

Ordering subsystem 250 represents tools that allow readers to obtain electronic books and related materials. In one embodiment, ordering subsystem 250 is implemented as an electronic marketplace (e.g., the ANDROID™ market implemented on the ANDROID™ operating system for smart phones and tablet computers). Third parties offer electronic books and related materials such as character guides, updates, workbooks, and the like. Some of these materials are available for purchase; others are free. In some embodiments, provision via other mechanisms (e.g., subscription, barter, “pay-per-view”) is supported, as may be desired by any subset of a reader community or content provider group. In one embodiment, ordering subsystem 250 also provides advertisements and other information relating to the images that cause content to be unlocked. For example, if a user joins a carpool and hears a portion of a book, the user may indicate that fact by identifying the user who was authorized for the audio playback, and then may obtain a discount to purchase an electronic version of the book. In another embodiment, ordering subsystem 250 offers a book in one version (text or audio) for one price, and in both versions for a second, somewhat higher, price.

Interface subsystem 260 of reader module 181 also includes user interface tools to facilitate use of electronic books and related features as described herein, such as switching between reading a book and ordering a related product. Reader module 181 is further configured to permit the running of user-selected applications to enhance a reader's ability to work with an electronic book. For instance, a reader may purchase an application that provides a chapter synopsis of the book so that if the reader has just heard chapter 3 of a book in a carpool group, the reader can be provided with a summary of the content of chapters 1 and 2. In addition, reader module 181 includes a daemon subsystem 270 to provide additional add-on features without the reader launching a visible application for such features.

As one example, a reader of a book with many illustrations may have on reader module 181 one or more daemons that allow presentation of those illustrations. In one embodiment those illustrations are presented in real time on user computer 180A; in another embodiment they are sent to the reader for later review, for example by SMS or email.

Where collaboration subsystem 240 recognizes multiple people listening to an audio book, such images are able to be sent to all users so that they can see the images that correspond to the audio that has been presented to them. As another example, a daemon subsystem prompts nearby users, in one example via Bluetooth communications, to smartphones and tablets within range, to automatically obtain full or partial features of a book being presented in audio format. Via collaboration subsystem 240 and ordering subsystem 250, those getting the prompt and opting in receive the images, as well as rights to access the electronic book (or, in some embodiments, an invitation to purchase the book or an advertisement related in some manner to the subject matter of the book).

### System Database

FIG. 3 illustrates a functional view of the system database 130 that stores data related to the content hosting system 110. The system database 130 may be divided based on the different types of data stored within. This data may reside in separate physical devices, or may be collected within a single physical device. System database 130 in some embodiments also provides processing related to the data stored therein.

User profile data storage 310 includes information about an individual user, to facilitate the synchronization, ordering, payment and collaborative aspects of system 100. Subscriber data storage 320 includes identifying information about the user. In some embodiments this is information provided by the user manually, while in other embodiments the user is given an opportunity to agree to the collection of such information automatically, e.g., the electronic books the user has obtained and the social network groups the user has joined. In some embodiments, subscriber data storage 320 also maintains information regarding how far the user has progressed in a particular book—in both text and audio versions. Just as known electronic reader systems (e.g., Google Books) synchronize the user's current reading location in a book so that the user can begin reading on a mobile device while on a bus and continue reading from the correct location on a desktop machine when at home, subscriber data storage 320 keeps track of progress of the user in text and audio versions of a book, and does so in a manner that is not solely local to one reading device. Thus, subscriber data storage 320 contains, in some embodiments, data about the user that is not explicitly entered by the user, but which is tracked as the user navigates through books and related materials.

Account data storage 330 keeps track of the user's payment mechanisms (e.g., Google Inc.'s CHECKOUT®) related to the user's ability to obtain content from system 100.

Social network 340 maintains in data storage devices the information needed to implement a social network engine to provide the collaborative features discussed herein, e.g., social graphs, social network preferences and rules that together facilitate communication among readers. In practice, it may be that various distributed computing facilities implement the social networking facilities and functions described herein. For example, certain existing features of the Google+social networking facility can implement some of the functions of social network facility 340. Social network 340 will be used here to reference any facilities to implement the social networking functions discussed herein.

Add-on data storage 350 maintains information for related features. In some embodiments, this includes non-static data relating to books (e.g., usage statistics, book ratings and reviews) and in some embodiments other information (e.g., school class rosters to determine which students will be allowed to obtain free text versions of books that have been partially presented in audio form in the classroom).

Textual book data storage 360 stores the actual textual content that is provided to users upon their request, such as electronic book files, as well as related information as may be maintained (e.g., metadata regarding image content for portions of the book that were previously accessed via an audio version to allow them to be viewed when the book is once again being read in its text version).

Audio book data storage 370 stores audio files that are provided to users upon their request, such as electronic book audio files, as well as related information as may be maintained (e.g., metadata regarding image content for portions of the book to allow such images to be sent for real-time display on user computer 180A or sent via SMS or email to a user for later review).

In various embodiments, system database 130 includes other data as well. For providers creating paid books or other content, system database 130 contains billing and revenue sharing information for the provider. Some providers may create subscription channels while others may provide single payment or free delivery of electronic books and related information. These providers may have specific agreements with the operator of the content hosting system 110 for how revenue will flow from the content hosting system 110 to the provider. These specific agreements are contained in the system database 130.

Alternatively, some providers may not have specific agreements with the operator of the content hosting system 110 for how revenue will flow from the content hosting service 110 to the provider. For these providers, system database 130 includes a standardized set of information dictating how revenue will flow from the content hosting system 110 to the providers. For example, for a given partner, the partner data may indicate that the content hosting system 110 receives 25% of the revenue for an item provided in both text-based and audio form as described herein, and the content provider receives 75%. Of course other more complex allocations can be used with variable factors based on features, user base, and the like.

Still further, system database 130 stores synchronization information regarding different versions of an electronic book. In one simple example, each of the textual book data storage 360 and the audio book data storage 370 are provided with metadata for synchronization purposes, for example a chapter count, page count or word count, depending on the level of synchronization desired. Methods for producing such metadata are described in further detail below.

In one embodiment, conventional mechanisms are used to implement many of the aspects of system database 130. For example, the existing mechanisms from Google Inc.'s BOOKS™, GOGGLES™, GMAILT™, BUZZ™, CHAT™, TALK™, ORKUT™, CHECKOUT™, YOUTUBE™, SCHOLAR™, BLOGGER™, GOOGLE+™ and other products include aspects that can help to implement one or more of storage facilities 310, 320, 330, 340, 350, 360 and 370 as well as modules 220, 230, 240, 250, 260 and 270. Google Inc. already provides eBook readers for ANDROID™ devices (phones, tablets, etc.), iOS devices (iPhones®, iPads® and other devices from Apple, Inc.) and various desktop Web browsers, and in one embodiment Google Inc.'s EDITIONS™ and EBOOKSTORE™ eBook-related applications and facilities are modified to provide the functionality described herein.

As mentioned above, user profile data storage 310 is usable on a per-reader basis and is also capable of being aggregated for various populations of subscribers. The population can be the entire subscriber population, or any selected subset thereof, such as targeted subscribers based on any combination of demographic or behavioral characteristics, or content selections. System-wide usage data includes trends and patterns in usage habits for any desired population. For example, correlations can be made between electronic books and add-ons that purchasers of those books choose (presumably related in some way to those books). In one embodiment, when a user obtains a new book, such data are used to recommend other related items the user might also be interested in obtaining (e.g., other books with audio versions narrated by the same voice actor). Valuation of items, relative rankings of items, and other synthesized information can also be obtained from such data.

### Computing Machine Architecture

FIG. 4 is a block diagram illustrating components of an example machine able to read instructions from a machine-readable medium and execute those instructions in a processor. Specifically, FIG. 4 shows a diagrammatic representation of a machine in the example form of a computer system 400 within which instructions 424 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 424 (sequential or otherwise) that specify actions to be taken by that machine. Further, while only a single machine is illustrated, the term “machine” shall also be taken to include any collection of machines that individually or jointly execute instructions 424 to perform any one or more of the methodologies discussed herein.

The example computer system 400 includes a processor 402 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 404, and a static memory 406, which are configured to communicate with each other via a bus 408. The computer system 400 may further include graphics display unit 410 (e.g., a plasma display panel (PDP), a liquid crystal display (LCD), a projector, or a cathode ray tube (CRT)). The computer system 400 may also include alphanumeric input device 412 (e.g., a keyboard), a cursor control device 414 (e.g., a mouse, a trackball, a joystick, a motion sensor, or other pointing instrument), a data store 416, a signal generation device 418 (e.g., a speaker), an audio input device 426 (e.g., a microphone) and a network interface device 420, which also are configured to communicate via the bus 408.

The data store 416 includes a machine-readable medium 422 on which is stored instructions 424 (e.g., software) embodying any one or more of the methodologies or functions described herein. The instructions 424 (e.g., software) may also reside, completely or at least partially, within the main memory 404 or within the processor 402 (e.g., within a processor's cache memory) during execution thereof by the computer system 400, the main memory 404 and the processor 402 also constituting machine-readable media. The instructions 424 (e.g., software) may be transmitted or received over a network (not shown) via network interface 420.

While machine-readable medium 422 is shown in an example embodiment to be a single medium, the term “machine-readable medium” should be taken to include a single medium or multiple media (e.g., a centralized or distributed database, or associated caches and servers) able to store instructions (e.g., instructions 424). The term “machine-readable medium” shall also be taken to include any medium that is capable of storing instructions (e.g., instructions 424) for execution by the machine and that cause the machine to perform any one or more of the methodologies disclosed herein. The term “machine-readable medium” includes, but not be limited to, data repositories in the form of solid-state memories, optical media, and magnetic media.

### Synchronization of Audio and Text Versions of an Electronic Book

The process of reading using electronic books opens up potential user experiences that have not been available in the world of paper books. Certain incentives to read can now be created that were not previously possible. Consider, for example, an electronic book implemented with both audio and text versions. Two valuable yet different uses are presented by such a book. First, a reader can both listen to the audio and follow the text of the book at the same time, either as an assistance to learning to read or to allow greater comprehension (e.g., by a student following both an audio version of a lecture and a corresponding textual transcription). Second, those who do not have sufficient time or desire to read a book in its text version can mix text-based traditional reading with audio presentation of the book's contents.

One feature not previously available in commercial electronic book reader systems is synchronization of a user's progress in audio and text versions of a work. Such a feature is very important for usability of mixed audio and text access to an electronic book, since few readers will have the patience to manually move around in either text or audio versions of the book to get to the point where they last left off. Users of such books with text and audio versions require the equivalent of an electronic bookmark to keep their place regardless of what medium they are using to progress through a book.

Existing electronic book synchronization methods do not address this need, since they are traditionally based on merely marking a place in one file (typically, marking a page in a text-based file). While this method would work for review of audio versions that are synthesized from the text file of a book, it would not work for situations involving separate files (e.g., a text file for the text version and an audio file for the audio version).

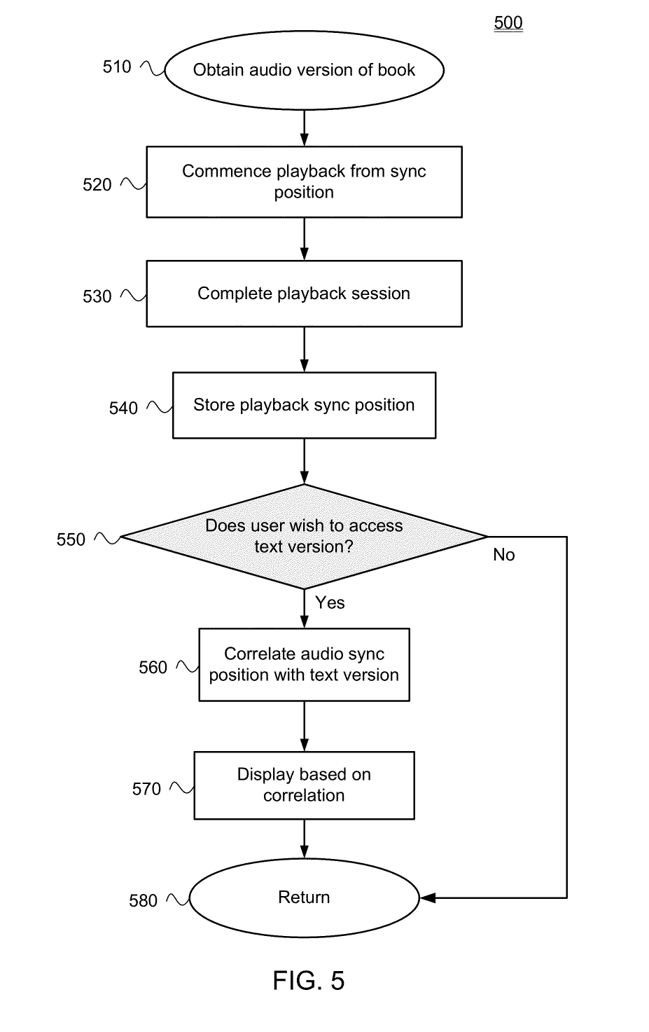

Referring now to FIG. 5, there is shown one embodiment of a method to synchronize audio and textual presentation of an electronic book to a user when a user seeks to access an audio version of an electronic book, and then later a text version of the book. A corresponding method (not shown) is used in the opposite situation, i.e., when the user seeks to access the text version first, and later the audio version. In the example illustrated in FIG. 5, processing begins at step 510 by obtaining an audio version of a book upon a user request for playback of an audio book. At step 520, processing determines the current sync position for playback and commences playback from that position. Techniques for tracking progress in an audio book are known, such as percentage completion or time code storage and retrieval. At step 530, the user completes the playback session, for instance by quitting an audio playback application on a smartphone (e.g., audio playback system 230 of reader module 181). At that point, the current sync position is stored in step 540, for instance by saving the position to subscriber data storage 320 of user profile data storage 310 in system database 130. To provide fail-safe operation should a network interruption occur, in some embodiments the position data is also saved periodically before completion of the playback session, for instance every minute during playback.

When the user next wants to access the book, a check 550 is made to see if the user wishes to access the text version of the book. If such access request is for the audio version rather than the text version, processing returns at step 580, since the synchronization position can be obtained conventionally by reference to the position stored in step 540. However, if the request is for the text version, processing moves to step 560, in which a correlation is determined between the audio sync position and the corresponding text sync position. In one embodiment, this is performed by a simple look-up table correlating the audio progress (via conventional time coding of the running audio or tracking percentage of the audio file that has been processed) with the text progress (based in this instance on pagination). A portion of a representative table is:

| | AUDIO (RUNNING TIME) | | | | |
|---|---|---|---|---|---|
| | 0:00 | 1:10 | 2:03 | 2:45 | 3:27 |
| TEXT (PAGE | 1 | 2 | 3 | 4 | 5 |
| NUMBER) | | | | | |

In this embodiment, textual display subsystem 220 is configured to commence display at the top of the page containing the content that was being played when the audio playback session was suspended. Thus, if the audio playback ceased at a running time of 2:25, text display is configured to start at the top of page 3.

In some instances, finer granularity is desired. In one embodiment, this is achieved through conventional interpolation between the table entries that bracket the cessation time. In that case, if playback ceased at 2:25, the starting portion of text is about halfway down page 3. Another embodiment achieves finer granularity by having a greater number of table entries. For example, table entries can be based on individual paragraphs in the text version of the book, with each such paragraph assigned a sequential number and a time entry being provided for when the audio version of the work begins to present that paragraph. Even finer tracking is possible by focusing on individual lines of a text (or even individual words or characters) rather than paragraphs. In order to help provide continuity and context for the reader, in some embodiments synchronization is intentionally offset so that, for instance, text display begins one paragraph or one page before the point where audio playback ceased. In practice it is found that many readers prefer to have a slight overlap in presentation to serve as a reminder of where the story was heading when they last stopped listening to, or visually reading, the book. In addition, positional information for a text version may be limited to “last page read” in any event, so later audio playback is in some embodiments set to commence at the beginning of such page to ensure that there is no gap in content.

Generation of the correlation table discussed above is in some embodiments performed based on previously available information. For instance, audio books are typically divided by chapter breaks, often with running times listed for each chapter. Likewise, many books have tables of contents with page numbers listed for the start of each chapter as well. If only coarse synchronization is needed, this information can merely be entered directly into a correlation table.

Typically, however, such correlation is too coarse to provide usable synchronization information, even with the use of interpolation. Another method to generate a correlation table is through generation of metadata. In some embodiments, this is performed in a semi-automatic manner, while in others it is fully automatic.

One embodiment for semi-automatic generation of a correlation table involves a human listener (typically someone associated with the content provider and therefore referred to for purposes of this portion of the disclosure as a “content provider”) operating a computer, e.g., content provider computer 180B. The content provider is presented with both an audio version of the book (via audio playback subsystem 230) and a textual version of the book (via textual display subsystem 220). In one embodiment, the content provider is free to navigate through the textual version at will, and is also free to pause and reposition playback of the audio version. In this embodiment, a daemon subsystem similar to daemon subsystem 270 as previously described is configured to allow the content provider to manually indicate correspondence between locations in the audio version and locations in the text version. In other embodiments, different types of applications running on content provider computer 180B, either within the context of a structure similar to reader module 181 or otherwise, are used to implement the functionality described herein.

Referring once again to FIG. 5, those skilled in the art will recognize that in various embodiments, similar steps are usable to allow presentation to an end user of both audio and text versions of an electronic book at the same time, for example to allow a student to follow both audio and text transcript versions of a lecture simultaneously. In one such embodiment, the audio version is used to determine progress, since it typically provides a more precise indication of location than the text version and since it allows the end user to “glance back” at prior pages of the transcript to understand portions currently being spoken without resetting the progress position. Variations suitable for other environments will be apparent to those skilled in the art, such as allowing end users to skip forward in the text transcript to see whether a concept being introduced in the audio will be expanded upon.

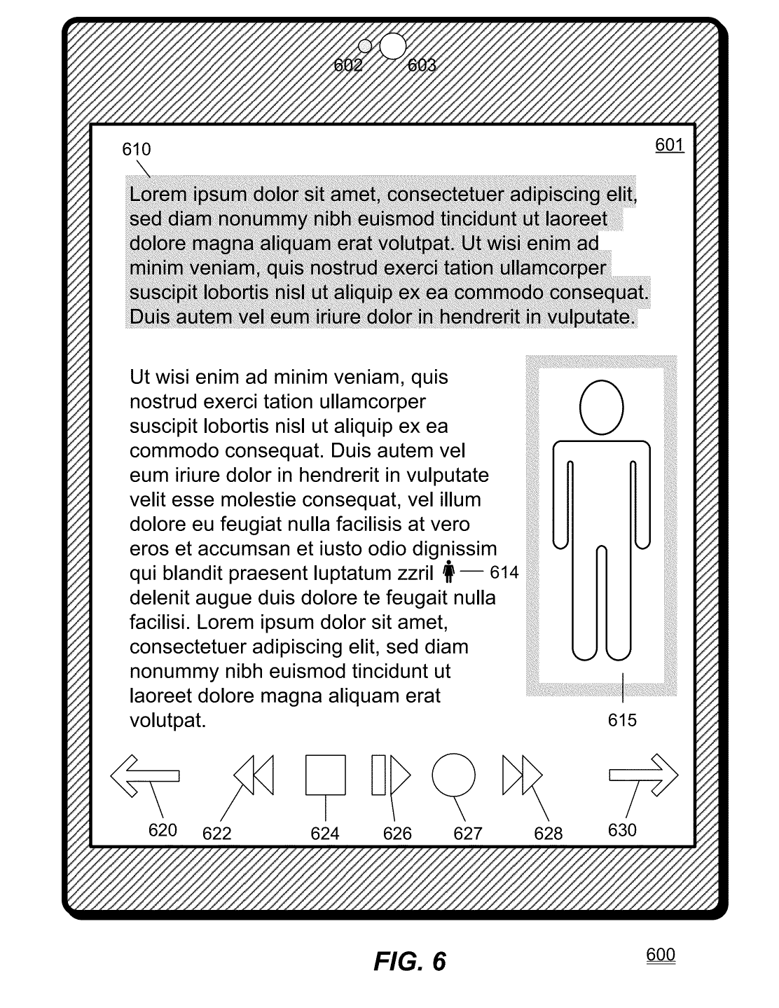

Referring now to FIG. 6, there is shown one embodiment of a portable computer 600 (e.g., a tablet computer running the ANDROID™ operating system) with a touch screen 601, a microphone 602, and a speaker 603, configured to allow generation of metadata in a semi-automatic manner as described herein. The user interface elements are displayed on the touch screen 601 and interacted with by a content provider touching them with a finger or stylus. In other embodiments, the content provider interacts with the user interface elements in other manners, for example by clicking on them using a pointing device such as a mouse.

On selection, the record button 627 begins the process of generating a correlation. In one embodiment, a preferences menu (not shown) allows a content provider to select from a variety of options, for instance to select a specific text version to be correlated with a specific audio version, to select a font size (or “zoom level”) of display for the text version of the book, and to select a speed of playback for the audio version of the book. The content provider also selects an option from a list of options, e.g., the beginning of the electronic book, the place where correlation was last established, or a user selected position.

In a first embodiment, the content provider moves a finger along the touch screen 601 such that words in the text are touched at about the same time as they are spoken in the audio version. Computer 600 then correlates the position of each text word in the text version with the corresponding position of each spoken word in the audio version. In some embodiments where such fine granularity is not needed, such positional data may be saved only for every other word, or every third word. In other embodiments where very fine granularity is needed, positional data may be generated at a per-character level or for every few characters (e.g., every syllable). As the content provider's finger reaches the bottom of the screen, the text display is automatically moved to the next page and the finger is repositioned to once again move along with the audio playback (with the audio automatically pausing and only resuming once the finger is placed on the first word of the new page). To account for blank pages and the like, pagination controls (discussed below) allow the content provider to manually page the text both forward and backward. Should the content provider's attention drift and the finger position no longer match the audio, the content provider can rewind the audio as described below and start again from any desired prior point in the playback.

In another embodiment, the content provider selects a portion of text, for example paragraph 610, in advance of when the corresponding audio is presented. Then, when the corresponding audio begins to play back that paragraph, the content provider employs a user interface control to indicate that fact. For example, the user interface may interpret a right mouse click, activation of the F1 key on the content provider's keyboard, or some other simple user action to indicate that the audio being played at that moment corresponds to the beginning of the marked paragraph. Either the same user action, or a slightly different one (the F2 key, for example) is then used to mark the end of that paragraph. In this embodiment, the content provider can very quickly mark the entire paragraph, for instance via the standard word processor interaction of three quickly repeated left mouse button clicks. Because both the beginning and the end of the paragraph are used as correlation points, the content provider can then ignore the next paragraph entirely and simply select, via the same mechanism, a third paragraph in order to mark its beginning and end.

In still another embodiment, rather than trailing a finger or using a keyboard command to provide correlation points for the start and end of a marked paragraph, computer 600 is configured for voice recognition such that the content provider can simply say commands, such as “start” and “end” to indicate when the audio for a marked paragraph begins and ends.

Furthermore, the content provider can correlate illustrations, e.g., 615, by clicking on them and pressing an appropriate key (F3, for example) when the audio playback reaches a point corresponding to the illustration and again when the audio playback passes the point where the illustration still appears to the reader of the text version. Some electronic books have other features, indicated by icon 614, that may relate to footnotes, annotations, character glossaries, links to other resources (e.g., an interactive map) or the like, and separate keys may also be used to generate correlations for such features.

Each time the content provider presses a key indicating a correlation, the correlation table is augmented. Correlation can instead be established in some embodiments by adding metadata to the digital audio file (e.g., a special code such as #42 indicating that the data are to be ignored for audio playback purposes but that the audio following that code comes from paragraph 42 of the text version of the work). Other embodiments add metadata to the digital text file (e.g., a special code #2.18 indicates that this text corresponds to a running time of 2 minutes, 18 seconds in the audio version). Still other embodiments create a third data structure, such as the correlation table in the example above, to record the correlation.

Granularity is likewise controllable in a number of ways in different embodiments. For example, sequential book text word numbers can be inserted in the audio version at every word break, line numbers can be inserted in the audio version file every five seconds, or paragraph numbers can be inserted every minute, depending on the granularity desired. On the text side, audio time code positions could be inserted in the text file, if desired, before every word that appears in the text. Environment-specific considerations, such as file size and reader device computing capability will determine the amount of synchronization data to include and the amount of interpolation to apply in computing a current position.

Rather than requiring mouse clicks and keystrokes from the content provider to select text and indicate when concurrent audio is playing, in still another embodiment the content provider merely touches the corresponding text that appears on the touch screen 601 whenever the corresponding audio plays, and the content provider determines how often to do that. A gesture on the touch screen, such as a downward stroke rather than a simple touch, is used in this embodiment to signify something other than text, for instance that the audio is now corresponding to text adjacent to an illustration 615.

The play/pause button 626 serves a dual purpose. Pressing it when the correlation process is running pauses audio playback; pressing it a second time reinstates playback from the place in the audio version where it was paused.

In contrast, the stop button 624 halts the correlation process altogether (i.e., without guaranteeing that the current position will be retained).

The rewind 622 button causes the current audio position to be moved rapidly back through the book. Similarly, the fast forward button 628 causes the current audio position to be moved rapidly forward through the book. In one embodiment, a brief press on buttons 622 or 628 cause a predetermined move backward or forward, for instance a ten-second movement, while a longer press causes continuous movement through the book. In one embodiment, a sped-up form of the audio version is played during fast forwarding to allow the user to keep track of the current position. When the user presses the play button 626, playback of the audio resumes from the new current position.

The forward 630 and back 620 buttons change the display on the touch screen 601 to show the next and previous pages of text in the electronic book, respectively. In the embodiment described here, the user moves the textual display manually as desired.

A second, more automated, system for generating metadata is performed at a first stage without any human intervention. Specifically, the utterances of the audio version of the book, stored in audio book data storage 370, are applied to a voice recognition subsystem, for instance implemented in third party module 120, and corresponding text strings are generated for each such utterance. In addition, time code or other positional information is maintained for each such utterance. Then, conventional text pattern matching is used to generate a correlation between the recreated text from the audio version of the book and the actual text version of the book (stored in textual book data storage 360). Even if rudimentary voice recognition engines are used, it is likely that sufficient matches will be found to permit a very detailed correlation mapping between the audio version and the text version, so that time coding or percentage of completion for the audio version can be mapped to pagination, paragraph numbering, line numbering, word numbering, character numbering or other positional information for the text-based version of the work. Once again, the correlation information may be encoded as metadata residing with the audio file, with the text file, or in a standalone data structure such as the correlation table illustrated above. Should such fully automated correlation fail for a portion of a book for one reason or another, any such failed portions can be marked and the partially automated techniques described above can be applied only for the failed portions.

Generally speaking, the embodiments discussed above permit enhancement of a user experience with electronic media by the application of correlated voice and text versions of the same electronic book using existing computing devices such as smart phones.

It should be noted that although the discussion herein has centered on correlating text and audio versions of the same book, those skilled in the art will readily recognize that these techniques can be used to help synchronize other experiences with electronic media as well. For instance, a user may have access to the same electronic book on one type of reading device that uses a proprietary format for the book (e.g., the .awz format used in AMAZON KINDLE® products) and on a second device that uses an open format for the book (e.g., the .epub open e-book standard promulgated by the International Digital Publishing Forum). Through use of correlation tables, metadata, third party modules and daemon subsystems as described herein, synchronization information from one type of reader device can be applied to another reader device, allowing a seamless reading experience for a user having both types of devices.

### Additional Considerations

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs executed by a processor, equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for providing electronic textbooks using a content hosting system through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A system to synchronize progress in audio and text versions of an electronic book, comprising:
a system database configured to maintain user progress data, audio book data corresponding to the audio version and textual book data corresponding to the text version, the audio book data including audio position information and the textual book data including text position information;
a correlation data store configured to maintain correlation data indicating correspondence between the audio position information and the text position information, and to allow generation of the user progress data from the correlation data;
an audio playback subsystem, the audio playback subsystem configured to present the audio version of the electronic book to a user responsive to the user progress data; and
a display subsystem, the display subsystem configured to present the text version to the user responsive to the user progress data.

2. The system of claim 1, wherein the audio position information is a time code.

3. The system of claim 1, wherein the audio position information is a percentage of completion.

4. The system of claim 1, wherein the text position information is a page number.

5. The system of claim 1, wherein the text position information is a paragraph number.

6. The system of claim 1, wherein the text position information is a line number.

7. The system of claim 1, wherein the text position information is a word number.

8. The system of claim 1, wherein the text position information is a character number.

9. The system of claim 1, wherein the correlation data is stored as metadata for at least one of the audio book data and the textual book data.

10. A system to correlate audio position information in an audio version of an electronic book with text position information in a text version of the electronic book, comprising:
a system database configured to maintain audio book data corresponding to the audio version and textual book data corresponding to the text version;
an audio processing subsystem, the audio processing subsystem in operable communication with the system database and configured to process the audio version so as to allow a comparison of the audio version with the text version; and
a correlation subsystem configured to generate correlation information establishing a correspondence between the audio position information and the text position information responsive to the comparison of the audio version and the text version, and to store the correlation information in the system database.

11. The system of claim 10, further comprising a display system configured to display the text version to a content provider, wherein the audio processing subsystem is an audio playback subsystem configured to play the audio version while the text version is displayed to the content provider, the correlation subsystem further including a user interface control configured to allow the content provider to establish the correspondence.

12. The system of claim 11, wherein the user interface control comprises a touch screen configured so that a finger press on a portion of the text version establishes a correspondence with a portion of the audio version being played at the time of the finger press.

13. The system of claim 12, wherein the touch screen is further configured to establish the finger press from a finger trace formed by following the text version as the audio version plays.

14. The system of claim 10, wherein the audio processing subsystem comprises a voice recognition subsystem configured to accept the audio version as input and produce as output a text rendition of the audio version, and wherein the comparison is of the text rendition of the audio version with the text version.

15. A computer-implemented method of synchronizing progress in audio and text versions of an electronic book, comprising:
maintaining in a system database user progress data, audio book data corresponding to the audio version and textual book data corresponding to the text version, the audio book data including audio position information and the textual book version including text position information;
maintaining, in a correlation data store, correlation data indicating correspondence between the audio position information and the text position information;
generating the user progress data responsive to the correlation data;
presenting the audio version to a user responsive to the user progress data; and
presenting, on a display subsystem, the text version to the user responsive to the user progress data.

16. The method of claim 15, wherein the audio position information is a time code.

17. The method of claim 15, wherein the audio position information is a percentage of completion.

18. The method of claim 15, wherein the text position information is a page number.

19. The method of claim 15, wherein the text position information is a paragraph number.

20. The method of claim 15, wherein the text position information is a line number.

21. The method of claim 15, wherein the text position information is a word number.

22. The method of claim 15, wherein the text position information is a character number.

23. The method of claim 16, wherein the correlation data is stored as metadata for at least one of the audio book data and the textual book data.

24. A computer-implemented method of correlating audio position information in an audio version of an electronic book with text position information in a text version of the electronic book, comprising:
maintaining in a system database audio book data corresponding the audio version and textual book data corresponding to the text version;
processing the audio version so as to allow a comparison of the audio version with the text version;
generating correlation information establishing a correspondence between the audio position information and the text position information responsive to said comparison; and
storing the correlation information in the system database.

25. The computer-implemented method of claim 24, further comprising displaying the text version to a content provider, playing the audio version to the content provider while the text version is displayed, and responding to operation of a user interface control to establish the correspondence.

26. The method of claim 25, wherein the user interface control comprises a touch screen, and responding to operation of the user interface control comprises establishing, responsive to a finger press on a portion of the text version, a correspondence with a portion of the audio version being played at the time of the finger press.

27. The method of claim 26, wherein the finger press is part of a finger trace formed by following the text version as the audio version plays.
